(19) United States
(12) Patent Application Publication
(10) Pub. No.: US 2014/0363626 A1
(43) Pub. Date: Dec. 11, 2014

(54) METHOD OF MANUFACTURING GLASS SUBSTRATE, AND GLASS SUBSTRATE

(71) Applicant: ASAHI GLASS COMPANY, LIMITED, Tokyo (JP)

(72) Inventors: Shintaro TAKAHASHI, Tokyo (JP); Leander Dittmann, Lausanne (CH); Adrien Chaize, Lausanne (CH)

(21) Appl. No.: 14/465,675

(22) Filed: Aug. 21, 2014

Related U.S. Application Data
(63) Continuation of application No. PCT/JP2013/053891, filed on Feb. 18, 2013.

(30) Foreign Application Priority Data
Feb. 27, 2012 (JP) 2012-040637

(51) Int. Cl. C03B 33/08

(52) U.S. Cl. CPC C03B 33/08
USPC 428/136; 65/112

(57) ABSTRACT

A method of manufacturing a glass substrate having a through hole, includes preparing a glass substrate having an average coefficient of thermal expansion in a range of 55×0⁻⁷/K to 120×10⁻⁷/K at 50° C. to 300° C., and a thickness of 0.2 mm or greater and 1 mm or less, and forming the through hole in the glass substrate using a laser-guided discharge technique.

### CROSS-REFERENCE TO RELATED APPLICATIONS

This application is a continuation application filed under 35 U.S.C. 111(a) claiming the benefit under 35 U.S.C. 120 and 365(c) of PCT International Application No. PCT/JP2013/053891 filed on Feb. 18, 2013, which is based upon and claims the benefit of priority of Japanese Patent Application No. 2012-040637 filed on Feb. 27, 2012, the entire contents of which are incorporated herein by reference.

### BACKGROUND OF THE INVENTION

1. Field of the Invention

The present invention relates to a glass substrate used for an interposer or the like, for example, and to a method of manufacturing the glass substrate.

2. Description of the Related Art

Conventionally, a method has been proposed to manufacture a glass substrate for an interposer by irradiating laser light on the glass substrate, in order to form a plurality of through holes (vias).

For example, Japanese Laid-Open Patent Publication No. 11-123577 proposes a method of forming a through hole by irradiating carbon dioxide gas laser light on a surface of a work piece.

As described above, a method has been proposed to form a through hole by irradiating carbon dioxide gas laser light on the surface of the work piece.

However, according to the method of forming the through hole by use of the carbon dioxide gas laser light, a suitable time is required to form the through hole. In addition, according to the method that uses the carbon dioxide gas laser light, distortion is generated in a glass substrate during a process in which a part melted by laser heating is cooled again. There is a problem in that the distortion may generate a crack in the glass substrate at a position where the through hole is formed. Particularly in a case in which the carbon dioxide gas laser light is irradiated on the glass substrate having a high coefficient of thermal expansion of 55×10⁻⁷/K or higher, for example, this problem becomes more notable.

In order to cope with this problem, it is conceivable to use excimer laser light having a short wavelength compared to that of the carbon dioxide gas laser light, in order to increase an irradiation fluence (energy density) of the laser light, and to shorten a machining time by forming a plurality of through holes simultaneously using a mask having through holes.

However, according to the method that uses the excimer laser light, there is a problem in that it is difficult to form a through hole having having a high aspect ratio (ratio of an overall length of the through hole with respect to a diameter of the through hole) exceeding 4, for example, with respect to the glass substrate having the high coefficient of thermal expansion. This is because, according to the method that uses the excimer laser light, debris (residue of machining) caused by laser ablation interferes with the laser machining along a depth direction to narrow a tip end of the through hole. Generally, in a case in which the excimer laser light is used, it may be regarded that the aspect ratio of the through hole is 4 or lower at the most.

Accordingly, a method that can form a through hole having a high aspect ratio with respect to the glass substrate having the high coefficient of thermal expansion is presently desired.

### SUMMARY OF THE INVENTION

The present invention is conceived in view of the above described problem, and one object of the present invention is to provide a method that can form a through hole having a high aspect ratio with respect to a glass substrate having a high coefficient of thermal expansion. In addition, one object of the present invention is to provide a glass substrate having a high coefficient of thermal expansion and a through hole having a high aspect ratio.

According to one aspect of the present invention, a method of manufacturing a glass substrate having a through hole may include:

preparing a glass substrate having an average coefficient of thermal expansion in a range of 55×10⁻⁷/K to 120×10⁻⁷/K at 50° C. to 300° C., and a thickness of 0.2 mm or greater and 1 mm or less; and

forming the through hole in the glass substrate using a laser-guided discharge technique.

In the method according to one embodiment of the present invention, the through hole may have an aspect ratio exceeding 4, where the aspect ratio is a ratio of an overall length of the through hole with respect to a maximum diameter of the through hole.

Particularly, the aspect ratio may be 10 or higher.

In addition, in the method according to one embodiment of the present invention, the maximum diameter of the through hole may be 60 μm or less.

Moreover, in the method according to one embodiment of the present invention, a plurality of through holes may be formed in the glass substrate, and a distance between centers of at least one pair of through holes may be 100 μm or less.

Furthermore, according to another aspect of the present invention, a glass substrate may include:

a through hole provided in the glass substrate,

wherein an average coefficient of thermal expansion of the glass substrate is in a range of 55×10⁻⁷/K to 120×10⁻⁷/K at 50° C. to 300° C.,

a thickness of the glass substrate is 0.2 mm or greater and 1 mm or less, and

the through hole has an aspect ratio exceeding 4, where the aspect ratio is a ratio of an overall length of the through hole with respect to a maximum diameter of the through hole.

In the glass substrate according to one embodiment of the present invention, the aspect ratio may be 10 or higher.

In the glass substrate according to one embodiment of the present invention, the maximum diameter of the through hole may be 60 μm or less.

In the glass substrate according to one embodiment of the present invention, a plurality of through holes may be formed in the glass substrate, and a distance between centers of at least one pair of through holes is 100 μm or less.

### BRIEF DESCRIPTION OF THE DRAWINGS

FIG. 1 is a flow chart schematically illustrating an example of a method of manufacturing a glass substrate according to one embodiment of the present invention;

FIG. 2 is a diagram schematically illustrating an example of a configuration of a laser-guided discharge machining apparatus utilizing a laser-guided discharge machining technique;

FIG. 3 is a perspective view schematically illustrating an example of the glass substrate according to one embodiment of the present invention; and

FIG. 4 is a photograph illustrating the glass substrate having a plurality of through holes in an practical example 1.

### DESCRIPTION OF THE PREFERRED EMBODIMENTS

A description will hereinafter be given of embodiments of the present invention with reference to the drawings.

(Method of Manufacturing Glass Substrate According to One Embodiment of Present Invention)

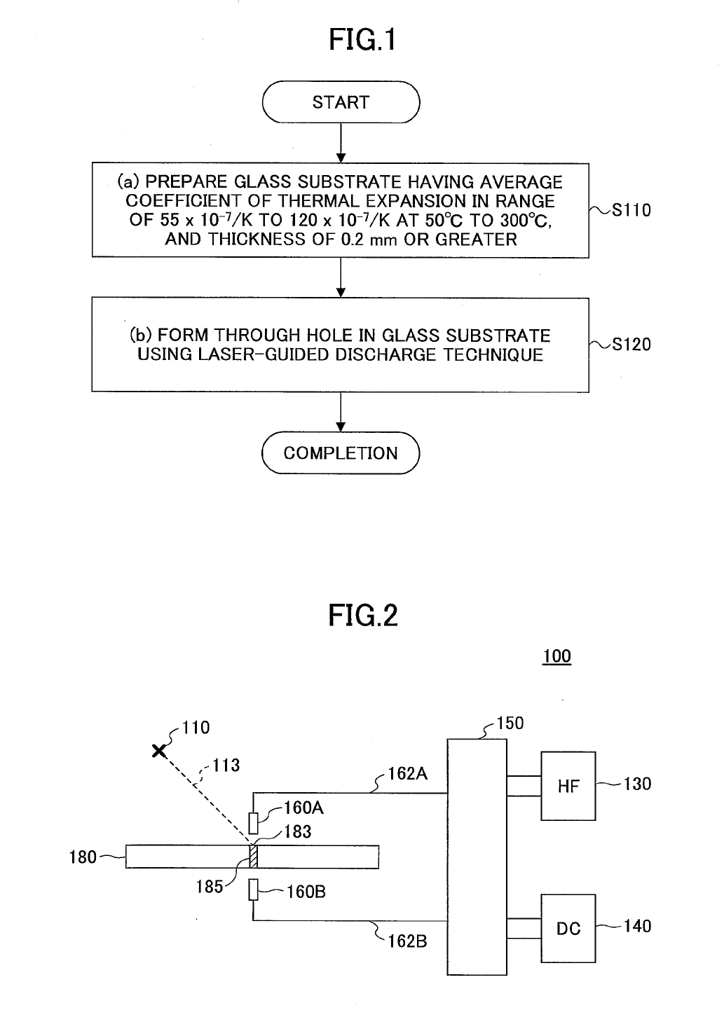

FIG. 1 is a flow chart schematically illustrating an example of a method of manufacturing a glass substrate according to one embodiment of the present invention.

As illustrated in FIG. 1, the method of manufacturing the glass substrate having a through hole according to one embodiment of the present invention includes:

(a) a process (step S110) to prepare a glass substrate having an average coefficient of thermal expansion in a range of 55×10⁻⁷/K to 120×10⁻⁷/K at 50° C. to 300° C., and a thickness of 0.2 mm or greater; and

(b) a process (step S120) to form the through hole in the glass substrate using a laser-guided discharge technique.

As described above, according to the method of forming the through hole by use of the carbon dioxide gas laser light, a suitable time is required to form the through hole. In addition, according to the method that uses the carbon dioxide gas laser light, distortion is generated in the glass substrate during a process in which a part melted by laser heating is cooled again. There is a problem in that the distortion may generate a crack in the glass substrate at a position where the through hole is formed. In the case in which the carbon dioxide gas laser light is irradiated on the glass substrate, this problem becomes more notable as the coefficient of thermal expansion of the glass substrate becomes higher.

In order to cope with this problem, it is conceivable to use excimer laser light having a short wavelength compared to that of the carbon dioxide gas laser light, in order to increase an irradiation fluence (energy density) of the laser light, and to shorten a machining time by forming a plurality of through holes simultaneously using a mask having through holes.

However, according to the method that uses the excimer laser light, there is a problem in that it is difficult to form a through hole having having a high aspect ratio (ratio of an overall length of the through hole with respect to a diameter of the through hole) with respect to the glass substrate having the high coefficient of thermal expansion. This is because, according to the method that uses the excimer laser light, debris (residue of machining) caused by laser ablation interferes with the laser machining along a depth direction to narrow a tip end of the through hole to a narrowed shape (tapered shape). Generally, in the case in which the excimer laser light is used, it may be regarded that the aspect ratio of the through hole is 4 or lower at the most.

Accordingly, according to the conventional method, there is a problem in that it is difficult to appropriately form a through hole having a high aspect ratio with respect to the glass substrate having the high coefficient of thermal expansion.

On the other hand, in one embodiment of the present invention, a “laser-guided discharge machining technique” is used when forming the through hole in the glass substrate.

As will be described later, this laser-guided discharge machining technique uses laser light to heat a desired position on the glass substrate, thereafter melts the heated position by guided discharge, and removes the melted material.

Compared to the method that only uses the laser light, this laser-guided discharge machining technique can more quickly form the through hole in the glass substrate. In addition, according to this laser-guided discharge machining technique, the melted material melted by the laser heating is quickly removed from the glass substrate by the guided discharge, and residue of the melted material is unlikely to remain on the glass substrate.

For this reason, according to the method in one embodiment of the present invention, it is possible to significantly suppress recooling of the melted part on the glass substrate during the machining. In addition, according to the method in one embodiment of the present invention, distortion is thus generated in a machining part of the glass substrate, and it is possible to significantly suppress generation of cracks in the glass substrate.

Therefore, according to the method in one embodiment of the present invention, one or two or more through holes can be formed in the glass substrate having a thickness of 0.2 mm or greater and a high coefficient of thermal expansion in a range of 55×10⁻⁷/K to 120×10⁻⁷/K, without generating cracks in the glass substrate.

In this specification, “coefficient of thermal expansion” refers to an average coefficient of thermal expansion at 50° C. to 300° C. In addition, this “coefficient of thermal expansion” refers to a value that is measured using a Thermo-Mechanical Analyzer (TMA), based on JIS (Japanese Industrial Standards) R3102 (1995). The coefficient of thermal expansion of the glass substrate having the through hole in one embodiment of the present invention is an intermediate value between a coefficient of thermal expansion of silicon and a coefficient of thermal expansion of a printed circuit board. In a case in which the glass substrate is used for a substrate of an interposer or the like, it is possible to obtain the effect of suppressing a break in a connecting electrode part caused by stress that is generated due to a difference between the coefficient of thermal expansion of silicon and the coefficient of thermal expansion of the printed circuit board.

Furthermore, according to the laser-guided discharge machining technique, Joule heat generated by dielectric breakdown of glass due to discharge quickly removes the melted material, so as not to allow the melted material to remain inside the through hole. For this reason, compared to the laser machining method that uses the excimer laser light, the method in one embodiment of the present invention can significantly increase the aspect ratio of the through hole. For example, in one embodiment of the present invention, it is relatively easy to form in the glass substrate a through hole having an aspect ratio exceeding 4.

In this specification, it is to be noted that the “aspect ratio” of the through hole refers to a “ratio of an overall length of the through hole with respect to a maximum diameter of the through hole”.

It is also to be noted that the “overall length of the through hole” refers to the thickness of the glass substrate at the position where the through hole is formed.

Moreover, in a normal case, the “maximum diameter of the through hole” corresponds to a diameter of the through hole (opening) at the surface of glass substrate on which the laser light is irradiated. This is because the surface of the glass substrate irradiated with the laser light is heated more, also in the method of the present invention, and the diameter of the through hole becomes larger at the irradiated surface of the glass substrate.

However, in special cases, such as a case in which the glass substrate is thin, it is to be noted that the diameter of the through hole (opening) at a surface of the glass substrate not irradiated with the laser light and the diameter of the through hole (opening) at the surface of the glass substrate irradiated with the laser light may become approximately the same. In addition, in a case in which both surfaces of the glass substrate are irradiated with the laser light, the diameters of the through hole (opening) at both surfaces of the glass substrate may become approximately the same.

Next, a more detailed description will be given of the method of manufacturing the glass substrate according to one embodiment of the present invention.

(Laser-Guided Discharge Machining Technique)

First, a brief description will be given of the laser-guided discharge machining technique utilized in one embodiment of the present invention.

In this specification, the “laser-guided discharge machining technique” refers to a generic name for the technique of forming the through hole in a work piece, by combining laser light irradiation with respect to the work piece and an inter-electrode discharge phenomenon, as will be described hereinafter.

FIG. 2 is a diagram schematically illustrating an example of a configuration of a laser-guided discharge machining apparatus utilizing the laser-guided discharge machining technique.

As illustrated in FIG. 2, a laser-guided discharge machining apparatus 100 includes a laser light source 110, a high-frequency high-voltage power supply 130, a DC high-voltage power supply 140, a switching unit 150, and a pair of electrodes 160A and 160B.

The laser light source 110 is not limited to, but may include, a carbon dioxide gas laser having an output of 1 W to 200 W, for example, and can form a focus spot in a range of 10 μm to 50 μm, for example, with respect to the work piece.

The electrodes 160A and 160B are electrically connected to conductors 162A and 162B, respectively, and these conductors 162A and 162B are connected to the high-frequency high-voltage power supply 130 and the DC high-voltage power supply 140 via the switching unit 150.

The switching unit 150 has a function of switching a connecting destination of the conductors 162A and 162B between the high-frequency high-voltage power supply 130 and the DC high-voltage power supply 140.

First, when forming the through hole using the laser-guided discharge machining apparatus 100 described above, a glass substrate 180, to be used as the work piece, is arranged between the electrodes 160A and 160B. An inter-electrode distance between the electrodes 160A and 160B is approximately 1 mm in a normal case. Further, by moving a stage (not illustrated) in a horizontal direction, the glass substrate 180 becomes arranged at a predetermined position with respect to the electrodes 160A and 160B.

Next, laser light 113 from the laser light source 110 is irradiated onto a target position (through hole forming position) on the glass substrate 180. As a result, a temperature rises at an irradiating position 183 on the glass substrate 180 irradiated with the laser light 113.

Within a short time after irradiating the laser light 113, the switching unit 150 connects the conductors 162A and 162B to the high-frequency high-voltage power supply 130, and consequently, a high-frequency high-voltage discharge occurs between the electrodes 160A and 160B. The discharge occurs exactly at the irradiating position 183 of the laser light 113. This is because the temperature at the irradiating position 183 is locally raised by the irradiation of the laser light 113, and a resistance of the glass substrate 180 at the irradiating position 183 is lower than that at other parts of the glass substrate 180.

A large energy is applied at the irradiating position 183 on the glass substrate 180 by the discharge occurring between the electrodes 160A and 160B, and the glass substrate 180 is locally melted.

Next, the switching unit 150 connects the conductors 162A and 162B to the DC high-voltage power supply 140, and a DC high-voltage is applied across the two electrodes 160A and 160B. Accordingly, melted material at the irradiating position 183 on the glass substrate 180 is removed, and a through hole 185 is formed at a desired position of the glass substrate 180.

The laser-guided discharge machining apparatus 100 illustrated in FIG. 2 is merely an example, and it is obvious to those skilled in the art that laser-guided discharge machining apparatuses having other configurations may be used.

As described above, according to the laser-guided discharge machining technique, the through hole can be formed in the glass substrate more quickly compared to the method that only uses the laser light. In addition, the laser-guided discharge machining technique has a feature in that the melted material melted by the laser heating is quickly removed from the glass substrate by the guided discharge, and the melted material is unlikely to remain on the glass substrate. Hence, in the method according to one embodiment of the present invention, it is possible to significantly suppress thermal distortion generated at the position where the through hole is formed, when compared to the conventional method that uses the carbon dioxide gas laser light.

Furthermore, the laser-guided discharge machining technique has a feature in that Joule heat generated by dielectric breakdown of glass due to discharge quickly removes the melted material, so as not to allow the melted material to remain inside the through hole. For this reason, according to the method in one embodiment of the present invention, it is relatively easy to form in the glass substrate a through hole having a high aspect ratio, when compared to the laser machining method that uses the excimer laser light.

From the effects described above, the method according to one embodiment of the present invention can appropriately form a through hole having a high aspect ratio, even with respect to a glass substrate having a thickness of 0.2 mm or greater and a coefficient of thermal expansion in a range of 55×10⁻⁷/K to 120×10⁻⁷/K.

Next, a more detailed description will be given of the method according to one embodiment of the present invention, in conjunction with each step illustrated in FIG. 1.

(Step S110)

As illustrated in FIG. 1, first, the method of forming the glass substrate having the through hole according to one embodiment of the present invention prepares the glass substrate to be machined.

A material used for the glass substrate is not limited to a particular material. The glass substrate may be formed by a glass substrate made of soda-lime glass, for example.

The glass substrate used in the present invention has a coefficient of thermal expansion in a range of 55×10⁻⁷/K to 120×10⁻⁷/K. The coefficient of thermal expansion is more preferably in a range of 55×10⁻⁷/K to 100×10⁻⁷/K.

In addition, the thickness of the glass substrate is not limited to a certain thickness as long as the thickness is 0.2 mm or greater and 1 mm or less. The thickness of the glass substrate may be in a range of 0.3 mm to 0.5 mm, for example. The thinner the glass substrate, the shorter the time it takes to form the through hole, but the more difficult the handling of the glass substrate becomes.

(Step S120)

Next, one or two or more through holes are formed in the glass substrate that is prepared in step S110, using the laser-guided discharge technique.

The laser-guided discharge technique to be applied to form the one or two or more through hole is not limited to a particular technique. For example, the laser-guided discharge machining apparatus illustrated in FIG. 2 may be used to form the one or two or more through holes in the glass substrate.

The laser light used may be carbon dioxide gas laser light. In addition, the output of the laser light may be in a range of 1 W to 200 W, for example. Further, a spot diameter of the laser light may be in a range of 10 μm to 50 μm. The shape of the spot of the laser light may be other than a circular shape, such as an oval shape, for example. The laser light may be irradiated from both sides of the glass substrate.

The high-frequency high-voltage power supply that is used may supply power at a frequency of 1 MHz to 100 MHz. The DC high-voltage power supply that is used may apply a DC voltage in a range of 1 kV to 250 kV across the two electrodes. The inter-electrode distance may be in a range of 1 mm to 10 mm, for example.

As described above, when forming the through hole in the glass substrate, the electrodes are arranged above and below the glass substrate. Next, the laser light is irradiated on the glass substrate, an in a state in which a target position (through hole forming position) is heated, the high-frequency voltage from the high-frequency high-voltage power supply is applied across the electrodes in order to generate discharge at the target position. Hence, the glass substrate is locally melted. Next, the DC high-voltage is applied across the electrodes to remove the melted material, and the through hole is formed in the glass substrate.

When successively forming a plurality of through holes, the electrodes may be moved with respect to the glass substrate every time the through hole is formed. In this case, a similar operation is carried out at a new target position, and the through hole can be formed successively in the glass substrate.

By the processes described above, one or two or more through holes can be formed in the glass substrate having the high coefficient of thermal expansion.

The aspect ratio of the through hole may exceed 4. The aspect ratio of the through hole may be 6 or higher (for example, 10), for example.

In addition, the maximum diameter of the through hole may be in a range of 10 μm to 60 μm, for example. The “maximum diameter of the through hole” typically corresponds to a diameter of the opening at the first or second surface of the glass substrate, however, it is to be noted that other parts of the through hole may have the “maximum diameter of the through hole”.

When a plurality of through holes are formed, a pitch P (μm) between the through holes is not limited to a particular value, and may be in a range of 20 μm to 300 μm, for example. The pitch P (μm) between the through holes may be in a range of 30 μm to 100 μm.

In this specification, the “pitch P (μm) between the through holes” refers to a distance between centers of a pair of mutually adjacent through holes.

(Glass Substrate According to Present Invention)

Next, a description will be given of the glass substrate according to one embodiment of the present invention.

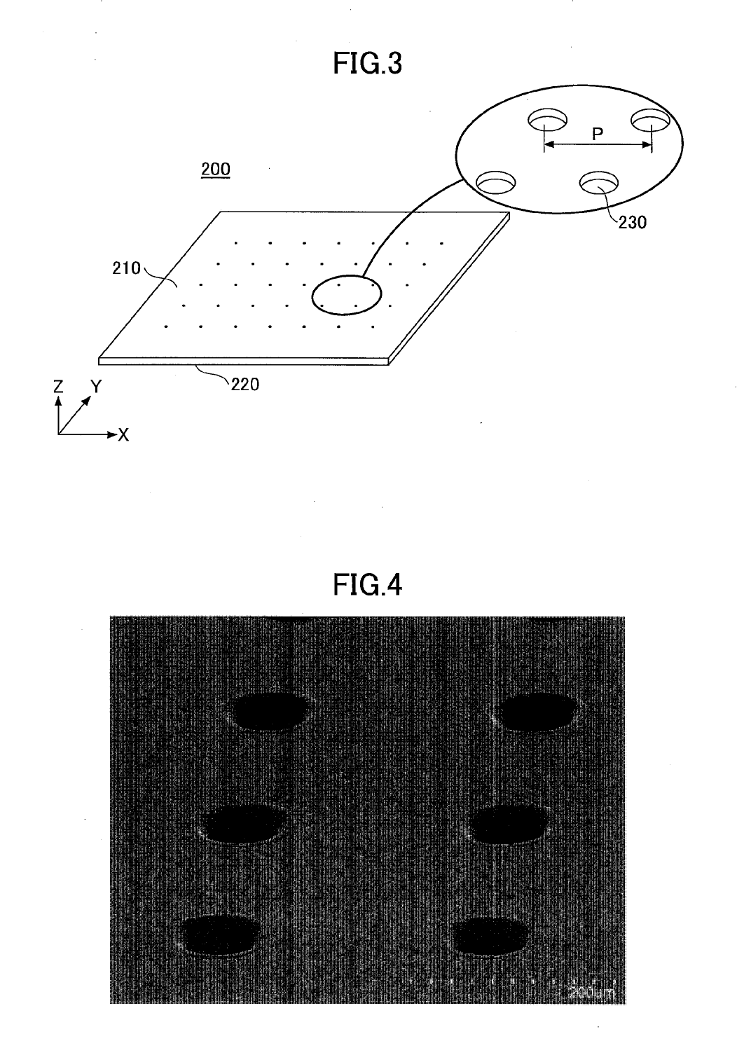

FIG. 3 is a perspective view schematically illustrating an example of the glass substrate according to one embodiment of the present invention.

As illustrated in FIG. 3, a glass substrate 200 according to one embodiment of the present invention has a first surface 210 and a second surface 220. In FIG. 3, the first surface 210 and the second surface 220 are mutually parallel, however, the two surfaces does not necessarily have to be parallel to each other. In addition, the shape of the glass substrate 200 does not necessarily have to be a flat shape illustrated in FIG. 3, and the shape may be a curved shape, such as a shape curved towards one surface, for example.

The glass substrate 200 has a coefficient of thermal expansion in a range of 55×10⁻⁷/K to 120×10⁻⁷/K. In addition, the thickness of the glass substrate 200 is 0.2 mm or greater.

Furthermore, as illustrated at the top right in FIG. 3, the glass substrate 200 according to the present invention includes one or two or more through holes 230 that penetrate the glass substrate 200 from the first surface 210 to the second surface 220.

In the example illustrated in FIG. 3, a cross section of each through hole 230, parallel to the first and second surfaces 210 and 220 (XY-plane), has an approximate circular shape, however, the cross sectional shape does not necessarily have to be the approximate circular shape.

In addition, although the shape of the through hole 230 along a thickness direction (Z-direction) of the glass substrate 200 may be unclear in FIG. 3, the shape of each through hole 230 along the Z-direction is not limited to a particular shape. For example, the shape of the through hole 230 along the Z-direction may be an approximate cylindrical shape, or the so-called “tapered shape” having a diameter that decreases from one surface (for example, the first surface 210) towards the other surface (for example, the second surface 220).

The glass substrate 200 according to one embodiment of the present invention has a feature such that the aspect ratio of at least one through hole 230 exceeds 4.

As described above, due to the effects of the debris generated during ablation, it is difficult for the conventional laser machining method that uses the excimer laser light to form a through hole having an aspect ratio exceeding 4 in the glass substrate.

In addition, according to the conventional laser machining method that uses the carbon dioxide gas laser light, to begin with, the effects of distortion are notable and the generation of cracks increase, and it is difficult to appropriately form the through hole in the glass substrate having a high coefficient of thermal expansion.

On the other hand, in the glass substrate 200 according to one embodiment of the present invention, it is possible to provide the glass substrate 200 including the through hole 230 having the aspect ratio exceeding 4 by applying the laser-guided discharge machining technique described above, even in a case in which the glass substrate 200 has a high coefficient of thermal expansion.

The material used for the glass substrate 200 is not limited to a particular glass material. For example, soda-lime glass, chemically strengthened glass, or the like may be used for the glass substrate 200.

The glass substrate 200 has a coefficient of thermal expansion in a range of 55×10⁻⁷/K to 120×10⁻⁷/K. The coefficient of thermal expansion is more preferably in a range of 55×10⁻⁷/K to 100×10⁻⁷/K.

In addition, the thickness of the glass substrate 200 is not limited to a certain thickness as long as the thickness is 0.2 mm or greater. The thickness of the glass substrate 200 may be in a range of 0.3 mm to 0.5 mm, for example.

The aspect ratio of the through hole 230 may be 6 or higher (for example, 10). In addition, a maximum diameter of the through hole 230 may be in a range of 10 μm to 60 μm. Further, a pitch P (μm) between the through holes is not limited to a particular value, and may be in a range of 20 μm to 300 μm, for example. The pitch P (μm) between the through holes may be in a range of 30 μm to 100 μm.

### PRACTICAL EXAMPLES

A description will hereinafter be given of practical examples of the present invention.

The above described laser-guided discharge machining apparatus illustrated in FIG. 2 was used to form a through hole with respect to a glass substrate, using the laser-guided discharge technique.

The glass substrate that is used as a work piece is made of soda-lime glass. In addition, the coefficient of thermal expansion of the glass substrate is 98×10⁻⁷/K, and the thickness of the glass substrate is 0.5 mm.

Prior to the process, in order to prevent matter scattered during the process from adhering again onto the surface of the glass substrate, a PET film is provided on both surfaces of the glass substrate.

The laser-guided discharge technique is applied under the following conditions:

Inter-electrode distance: 1 mm to 2 mm

Laser light source: Carbon dioxide gas laser light (60 W)

High-frequency high-voltage power supply frequency: 7.3 MHz (applied 30 microseconds after laser light irradiation)

Heating time (that is, applying time of the laser light and the high-frequency high-voltage power supply): Approximately 700 microseconds

DC high-voltage power supply: 5000 V (applied within approximately 30 microseconds after the heating time elapses)

The through hole is successively formed, one by one, by carrying out the above described process again by changing relative positions of the glass substrate and the electrodes after the process is completed once.

FIG. 4 illustrates a state of the glass substrate after the process (enlarged view of the openings of the through holes).

As illustrated in FIG. 4, a plurality of through holes are formed in the glass substrate. As a result of visual observation, no cracks or the like that may cause a problem were generated, and the glass substrate was in a proper state.

A maximum diameter of the through hole (corresponding to the diameter of the opening at one of the surfaces of the glass substrate) was approximately 50 μm. Because the thickness of the glass substrate is 0.5 mm the aspect ratio of the through hole that is obtained was approximately 10.

In addition, the pitch P (μm) between the through holes was approximately 200 μm.

Therefore, it was confirmed that the method according to one embodiment of the present invention can form the through hole having the high aspect ratio even with respect to the glass substrate having the high coefficient of thermal expansion.

The present invention may be utilized for a method of manufacturing a glass substrate that is usable by an interposer or the like.

According to the embodiments and the practical examples of the present invention, it is possible to provide a method that can form a through hole having a high aspect ratio with respect to a glass substrate having a high coefficient of thermal expansion. In addition, according to the embodiments and the practical examples of the present invention, it is possible to provide a glass substrate having a high coefficient of thermal expansion and a through hole having a high aspect ratio.

Further, the present invention is not limited to these embodiments and practical examples, but various variations, modifications, or substitutions may be made without departing from the scope of the present invention.

What is claimed is

1. A method of manufacturing a glass substrate having a through hole, comprising:
preparing a glass substrate having an average coefficient of thermal expansion in a range of 55×10⁻⁷/K to 120×10⁻⁷/K at 50° C. to 300° C., and a thickness of 0.2 mm or greater and 1 mm or less; and
forming the through hole in the glass substrate using a laser-guided discharge technique.

2. The method as claimed in claim 1, wherein the through hole has an aspect ratio exceeding 4, where the aspect ratio is a ratio of an overall length of the through hole with respect to a maximum diameter of the through hole.

3. The method as claimed in claim 1, wherein the aspect ratio is 10 or higher.

4. The method as claimed in claim 1, wherein the maximum diameter of the through hole is 60 μm or less.

5. The method as claimed in claim 1, wherein
a plurality of through holes are formed in the glass substrate, and
a distance between centers of at least one pair of through holes is 100 μm or less.

6. A glass substrate comprising:
a through hole provided in the glass substrate,
wherein an average coefficient of thermal expansion of the glass substrate is in a range of 55×10⁻⁷/K to 120×10⁻⁷/K at 50° C. to 300° C.,
wherein a thickness of the glass substrate is 0.2 mm or greater and 1 mm or less, and
wherein the through hole has an aspect ratio exceeding 4, where the aspect ratio is a ratio of an overall length of the through hole with respect to a maximum diameter of the through hole.

7. The glass substrate as claimed in claim 6, wherein the aspect ratio is 10 or higher.

8. The glass substrate as claimed in claim 6, wherein the maximum diameter of the through hole is 60 μm or less.

9. The glass substrate as claimed in claim 6, wherein
a plurality of through holes are formed in the glass substrate, and
a distance between centers of at least one pair of through holes is 100 μm or less.
